(19) United States
(12) Patent Application Publication
(10) Pub. No.: US 2009/0260930 A1
(43) Pub. Date: Oct. 22, 2009

(54) CLUTCH ARRANGEMENT FOR A WEAR ADJUSTMENT DEVICE FOR A DISK BRAKE

(76) Inventor: Joachim Lotz, Gevelsberg (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 12/373,132

(22) PCT Filed: Nov. 8, 2006
(86) PCT No.: PCT/EP06/10685

§ 371 Date: Jan. 13, 2009

(30) Foreign Application Priority Data
Jul. 11, 2006 (DE) 20 2006 010 681.2

(51) Int. Cl. F16D 65/56

(52) U.S. Cl. 188/196 BA

(57) ABSTRACT

The description relates to a clutch arrangement for a wear adjustment device for a disk brake in vehicles, in which wear adjustment device a rotating lever which is actuated during braking acts on at least one displaceable element which actuates at least one adjusting spindle which presses a brake lining in direction of a brake disk. The adjustment device is so designed that it adjusts the adjusting spindle by continued rotation, a one-way rotation and overload clutch arrangement which blocks in the adjusting direction being provided for this purpose. The one-way rotation and overload clutch arrangement has stamped metal parts, and the shaping area is generated by means of plastic injection molding.

The present application claims priority from PCT Patent Application No. PCT/EP2006/010685 filed on Nov. 8, 2006, which claims priority from German Patent Application No. 20 2006 010 681.2 filed on Jul. 11, 2006, the disclosure of which is incorporated herein by reference in its entirety.

### BACKGROUND OF THE INVENTION

1. Field of the Invention

The invention is directed to a clutch arrangement for a wear adjustment device for a disk brake in vehicles, in which wear adjustment device a rotating lever which is actuated during braking acts on at least one displaceable element which actuates at least one adjusting spindle which presses a brake lining in direction of the brake disk, wherein the adjustment device is so designed that it adjusts the adjusting spindle by continued rotation, a one-way rotation and overload clutch arrangement which blocks in the adjusting direction being provided for this purpose.

2. Description of Related Art

A clutch arrangement of the type mentioned above for a wear adjustment device is already known from DE 198 14 807 C2. Further, reference is had to DE 197 29 024 C1.

### SUMMARY OF THE INVENTION

It is the object of the invention to simplify the production of the clutch arrangement, particularly of the adjustment device, and therefore to make the clutch arrangement less expensive.

The above-stated object is met in different ways. According to one embodiment form, stamped metal parts are provided in the one-way rotation and overload clutch arrangement instead of drawn and hot-pressed metal parts, and the shaping area is generated by means of plastic injection molding.

According to another embodiment form, a plastic part which is injection molded in one piece from plastic is provided in the one-way rotation and overload clutch arrangement instead of metal spring elements.

This is advantageous because it not only simplifies production but also substantially facilitates assembly because the one-piece structural component part is easier to mount than the plurality of metal springs that are used.

The known freewheel requires a fit for securing axially. Further, the support is overdimensioned in this location. According to the invention, however, end radii which are overmolded with plastic are provided in the one-way rotation and overload clutch arrangement instead of machined metal outer surfaces to produce a fit for axially securing.

The plastic is advantageously shrunk on the outer surface during the cooling of the end radii overmolded by plastic.

The support which can be transmitted by the shrunk-on plastic can be reinforced by means of a switching plate and/or also by grooves or projections in the outer surface.

In another advantageous embodiment form, a one-way rotation and overload clutch arrangement is provided in which sliding bearings are used for the supporting bearings of the freewheel arrangement instead of needle bearings. This also provides a crucially significant simplification of production and assembly.

A cold-pressed blank is used starting material for producing the clutch arrangement. This cold-pressed blank is preworked by cutting, including drilling, and must then be case hardened. Finally, after this heat treatment, finish cutting work is required to achieve the fit quality.

This is disadvantageous in that the strength of the material has already been greatly increased by the multiple-step pressing process by the time spherical stamping is to be carried out. When stamping soft-annealed strip materials, the stamp is improved with respect to its impression and has a longer service life. Consequently, the one-way rotation and overload clutch arrangement is outfitted according to the invention with a clutch bushing that is fashioned from soft-annealed strip material by stamping.

In an advantageous manner, a clutch bushing and a tubular switching part which is preferably worked up from seamlessly drawn pipe are inserted one inside the other in the one-way rotation and overload clutch arrangement and are connected to one another by plastic injection molding. This facilitates production and makes it less expensive.

Finally, it is advantageous, according to another embodiment form of the invention, when the one-way rotation and overload clutch arrangement makes use of plastic injection-molded connections such as the connection between the clutch bushing and the switching part instead of machined metal stop edges.

According to another further development of the invention, the one-way rotation and overload clutch arrangement has, as a clutch bushing, a sleeve with a metal cap with radial press fit which is fitted thereto and which has recesses.

The freewheel sleeve can have a metal ring for stabilizing the radial dimension and this can be manufactured in a conventional manner as a closed ring or, optionally, from curved strip material whose end faces engage inside one another in a positive engagement.

The curved ring which is also closed at the front ends can be perforated for improving its connection with the plastic.

### BRIEF DESCRIPTION OF THE DRAWINGS

FIG. 1 shows the adjustment device for disk brakes known from DE 198 14 807 C2;

FIG. 2 shows the associated one-way rotation and overload clutch arrangement according to the prior art;

FIG. 3A shows an exploded view of a first variant of the one-way rotation and overload clutch arrangement according to the invention;

FIG. 3B shows an enlarged view of the assembled one-way rotation and overload clutch arrangement according to FIG. 3A;

FIG. 3C shows a view of the arrangement shown in FIG. 3B from the left-hand side;

FIG. 3D shows an isometric view of the freewheel shift fork in a 1:1 scale;

FIG. 3E shows an enlarged axial sectional view through the freewheel shift fork;

FIG. 3F shows a front view;

FIG. 3G shows a top view;

FIGS. 3H, 3I, 3J, 3K, 3L, 3M, 3N, 3O and 3P show different views of the shift fork;

FIGS. 3Q, 3R, 3S, 3T and 3U show different views of the pipe stop;

FIG. 4A shows an exploded view of an embodiment form in which the shift fork is made of plastic;

FIG. 4B shows an enlarged view of an axial sectional view of the assembled arrangement according to FIG. 4A;

FIG. 4C shows a sectional view along line B-B of FIG. 4B;

FIG. 4D shows the three parts of the plastic shift fork in an exploded view;

FIGS. 4E to 4G show three views of the plastic injection molding of the assembled plastic shift fork;

FIGS. 4H and 4I show the shift fork plate as a detail;

FIGS. 4J, 4K and 4L show various views of the assembled plastic shift fork;

FIG. 5A shows an exploded view of an alternative embodiment form;

FIG. 5B shows an enlarged axial view of the assembled arrangement according to FIG. 5A;

FIG. 5C shows a sectional view along section line B-B in FIG. 5B;

FIG. 5D shows a perspective view of the shift fork plate and plastic injection molding before assembly;

FIGS. 5E to 5I show various views of the assembled arrangement;

FIGS. 5J and 5K show two views of the shift fork plate;

FIG. 6A shows an exploded view of an embodiment form with a three-part clutch bushing;

FIG. 6B shows an enlarged view of an axial section through the assembled arrangement according to FIG. 6A;

FIG. 6C is a view of the arrangement according to FIG. 6B seen from the left-hand side;

FIG. 6D is an exploded view of the three-part clutch bushing;

FIG. 6E is an exploded view from the back;

FIG. 6F shows a front view of the three-part clutch bushing;

FIG. 6G shows a side view of the three-part clutch bushing;

FIG. 6H shows an axial sectional view of the three-part clutch bushing;

FIGS. 6I to 6N show different views of the clutch bushing plate;

FIGS. 6O to 6Q show different views of the clutch bushing sleeve;

FIG. 7A shows a side view of another embodiment form;

FIG. 7B shows a view from the left-hand side according to FIG. 7A;

FIG. 7C shows a radial sectional view;

FIG. 7D shows an axial sectional view;

FIG. 7E shows a perspective view;

FIG. 7F shows a side view with partially removed plastic to illustrate a reinforcement of the arrangement by means of a perforated metal sleeve on the one hand and by a sheet metal facing of the shift fork plate teeth on the other hand;

FIG. 8A shows an axial sectional view of a two-part clutch bushing with attached metal cap; and

FIG. 8B shows a perspective view of a freewheel sleeve with metal strip reinforcement.

### DETAILED DESCRIPTION OF EMBODIMENTS

It is to be understood that the figures and descriptions of the present invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein.

The present invention will now be described in detail on the basis of exemplary embodiments.

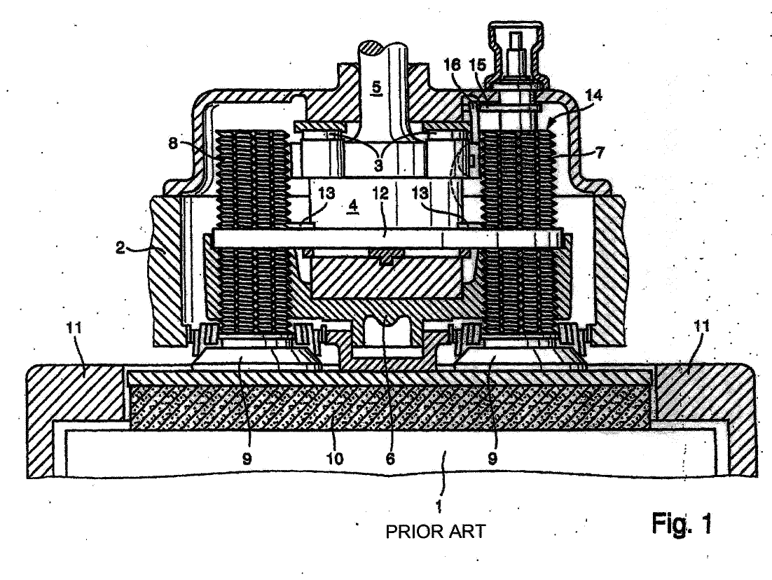

FIG. 1 is taken from the prior art, namely, DE 198 14 807 C2, and shows a brake disk 1 within the meaning of this reference. A brake caliper 2, only part of which is shown, i.e., the part on the brake disk 1 side receiving the tensioning device, engages over the brake disk 1. A cam lever 4 is mounted in the brake caliper 2 so as to be swivelable around an axis of rotation extending parallel to the plane of the brake disk 1 by means of roller bearings 3 having the approximate shape of half-shells. The cam lever 4 is driven by a lever 5 whose end can be connected to the piston of a brake cylinder held at the brake caliper 2 or to a mechanical brake linkage. The cam lever 4 is connected by its cam to a cross member 6 which extends parallel to the plane of the brake disk 1 within the brake caliper 2 and is movable vertical to this plane. The two ends of the cross member 6 are screwed to an adjusting spindle 7 and 8, respectively, so as to be adjustable. The two adjusting spindles 7 and 8 extend vertical to the plane of the brake disk 1 inside the brake caliper 2 and end facing the latter with pressure pieces 9. A brake lining 10 which can be pressed against the brake disk 1 contacts the pressure pieces 9. The two adjusting spindles 7 and 8 have an axial toothing which intersects their thread, and a toothed belt 12 which connects the two adjusting spindles 7 and 8 to one another so as to be fixed with respect to relative rotation engages in this axial toothing. Holding members 13 are located at the cross member 6 for guiding the toothed belt 12. The adjusting spindle 7 is provided with a rotary drive 14 which is located substantially in an axial open recess of the adjusting spindle 7 remote of the brake disk. The rotary drive 14 carries a drive lever 15 which projects out radially and whose free end cooperates with a stop pin 16.

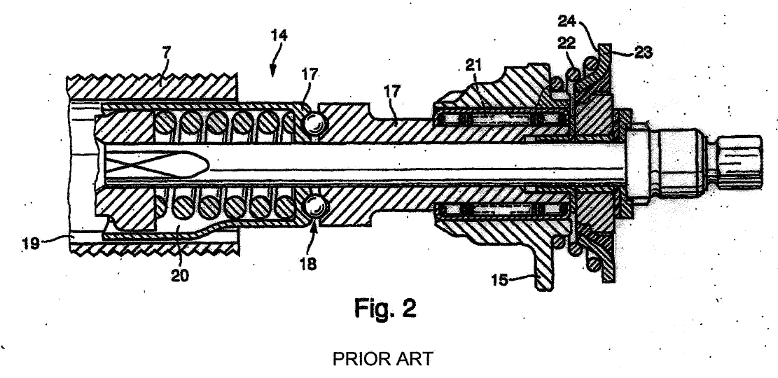

FIG. 2 shows the rotary drive 14 in longitudinal section. A shaft 17 is formed from two parts arranged axially one behind the other, a torque limiting device (balls 25) being arranged therebetween. One (left-hand) portion of the shaft 17 penetrates into the adjusting spindle 7 which is provided with at least one axial groove 19 in which a projection 20 of the driveshaft 17 engages. The lever 15 is arranged on the shaft 17 by means of a clamping roller freewheel 21 mounted on roller bearings. A conical helical pressure spring 22 is arranged coaxial to the shaft 17 and contacts the lever 15 by its final turn on one side and contacts a stationary part 23 by its final turn on the other side. The widened end of the conical helical pressure spring 22 faces the stationary part 23. The contact face of the stationary part 23 for the conical helical pressure spring 22 is formed as a friction surface 24.

To compensate for play caused by wear, the lever 15 is rotated in an advancing direction. This rotating movement is transmitted by the engaged clamping roller freewheel 21 to the shaft 17, from where it is transmitted to the adjusting spindle 7. The adjusting spindle 7 rotates relative to the cross member 6, and an axial displacement of the adjusting spindle 7 takes place by which the brake lining is adjusted in direction of the brake disk 1. An unwanted swiveling of the lever 15 is prevented by the conical helical screw spring 22. The end of the conical helical pressure spring 22 contacting the lever 15 can be connected to the lever 15 by positive engagement.

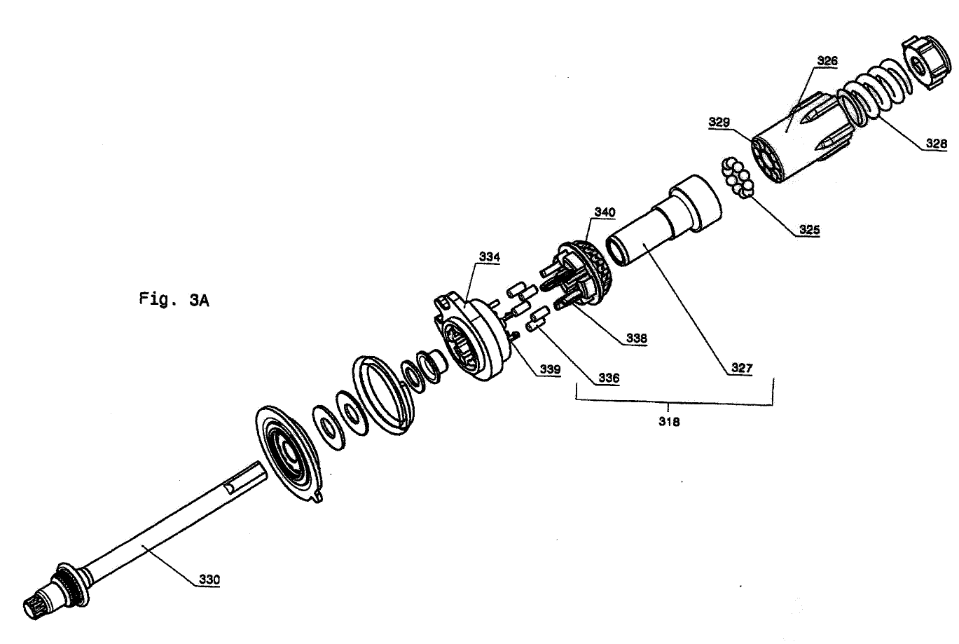

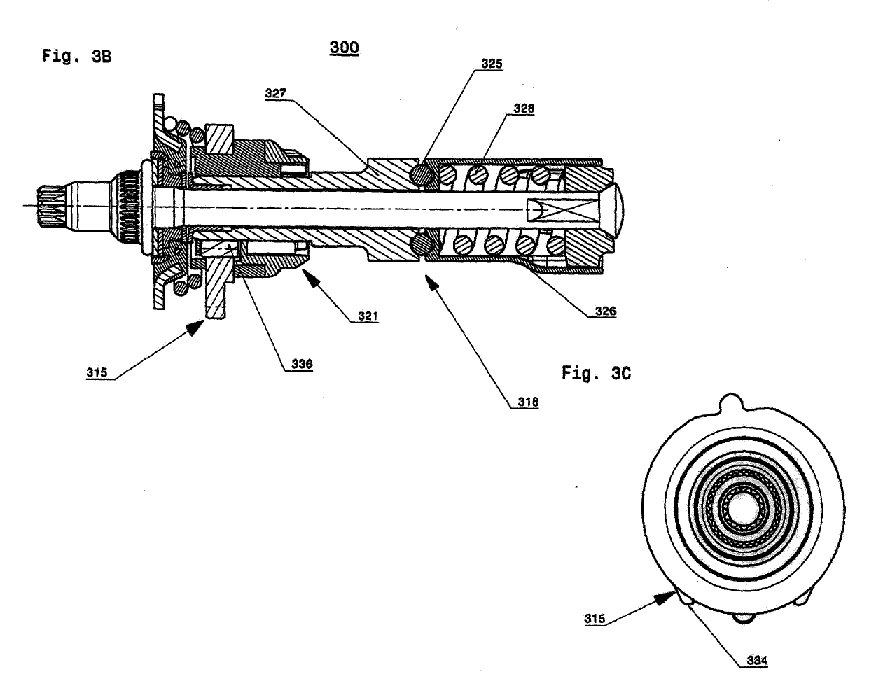

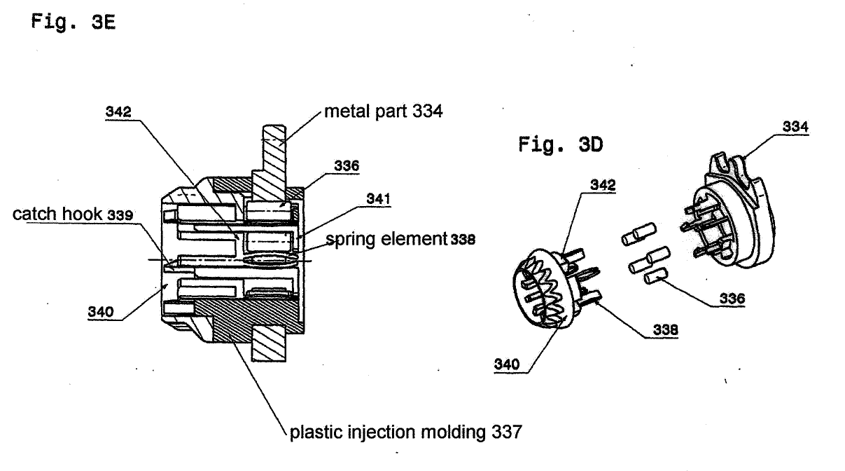

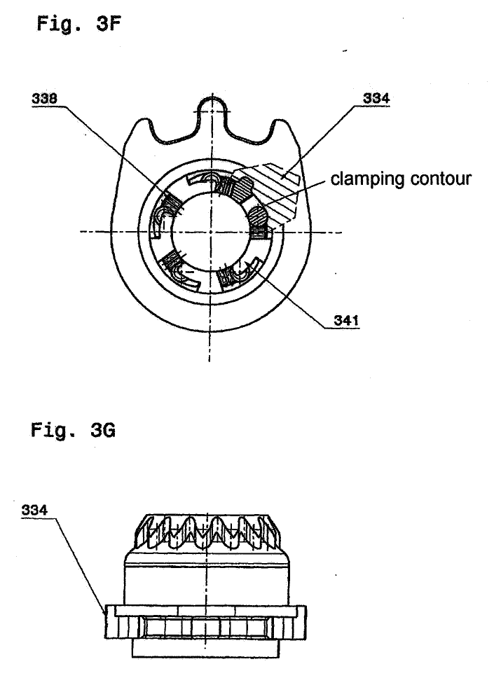

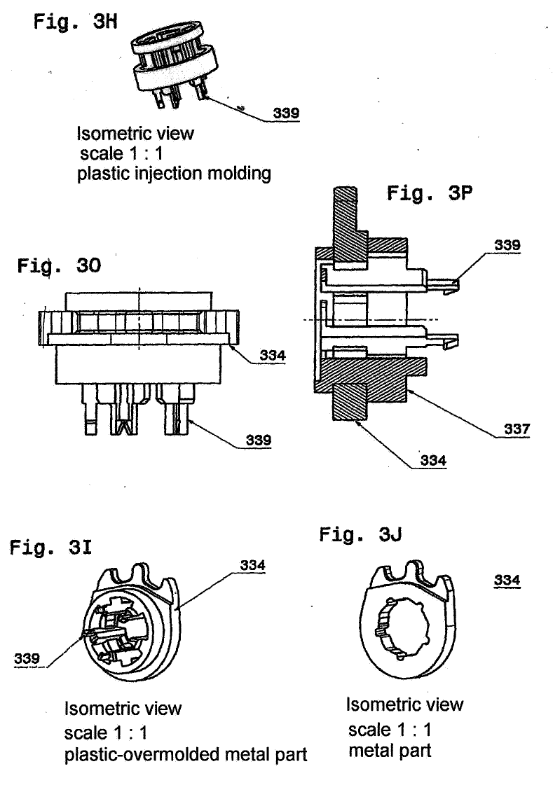

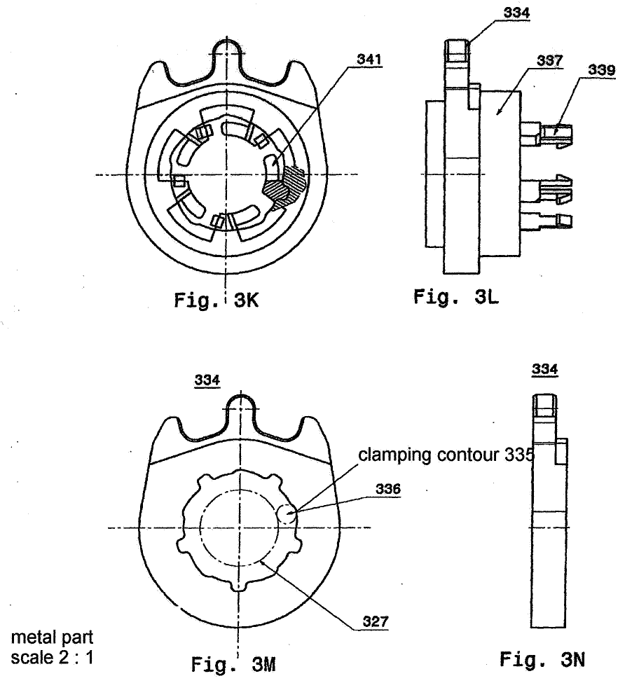

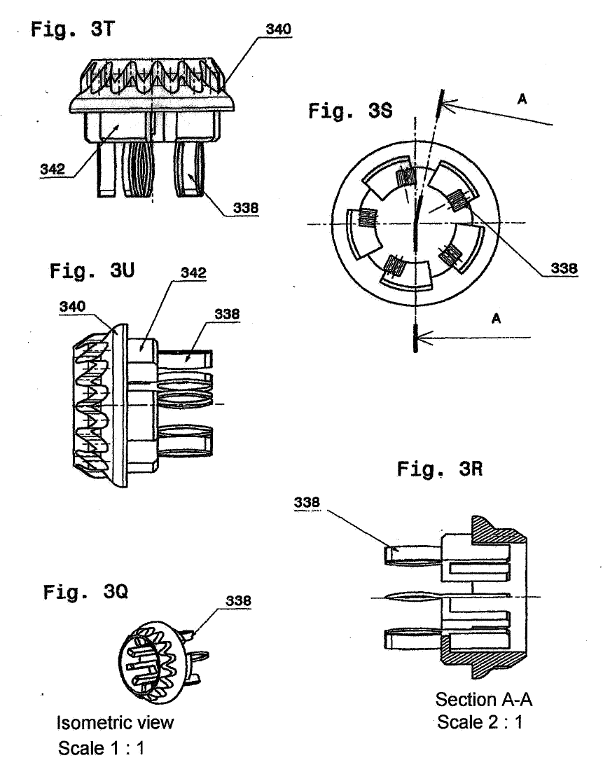

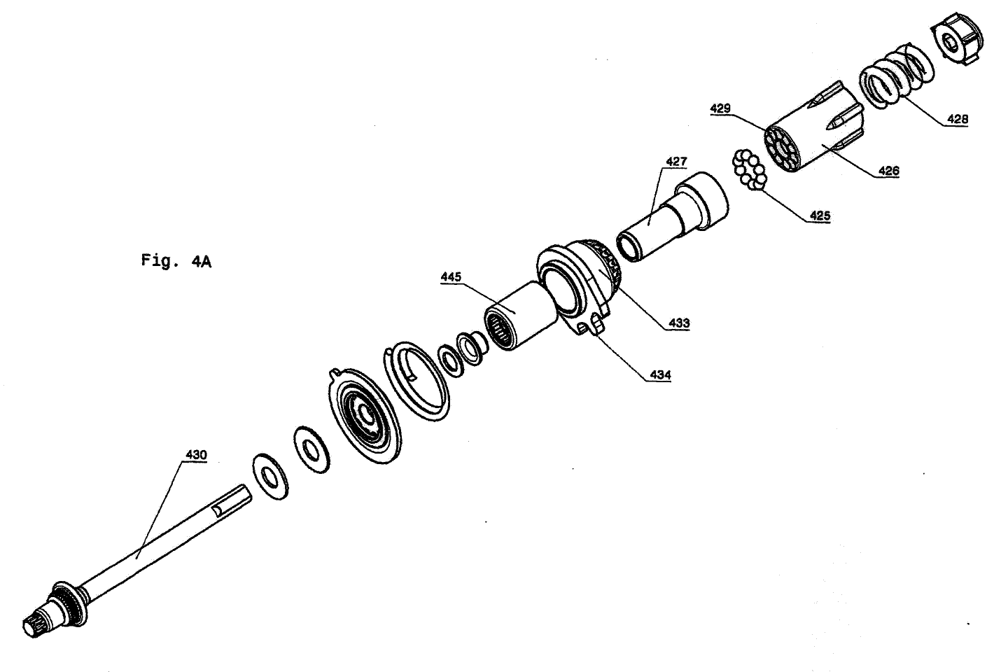

A wear adjustment device 300 constructed according to the invention for a disk brake which is not shown in more detail but which is constructed similar to that in FIGS. 1 and 2 is shown in the assembled state in FIG. 3A in an exploded view in a scale of approximately 1:1 and in FIG. 3B in a scale twice that of FIG. 3A. In the wear adjustment device 300, a rotary lever 315 which is actuated during braking acts on at least one displaceable element which actuates at least one adjusting spindle which presses on a brake disk in a brake lining. The wear adjustment device is constructed in such a way that it adjusts the adjusting spindle (see reference number 7 in FIGS. 1 and 2) by continued rotation. A one-way rotation and overload clutch arrangement 318 which blocks in the adjusting direction is provided for this purpose. The overload clutch arrangement 318 comprises a clutch shaft 330 supporting a clutch sleeve 326 on one side and a clutch bushing 327 on the other side. These parts are acted upon by the axial pressure of a pressure spring 328. As can be seen in FIG. 3A, the clutch sleeve 326 has recesses 329 which are adapted to its spherical shape and which are also provided in the prior art (FIG. 2). The clutch bushing likewise has corresponding recesses 329.

The force of the spring 328 presses the balls 325 into these recesses and a certain torque must be overcome in order to rotate the two clutch parts 326 and 327 relative to one another because the balls must move out of the recesses against the force of the pressure spring 328. The exact torsional force at which the clutch is disengaged when overloading depends on the accuracy of the machining of the recess 329 and the corresponding surface of the clutch bushing 327.

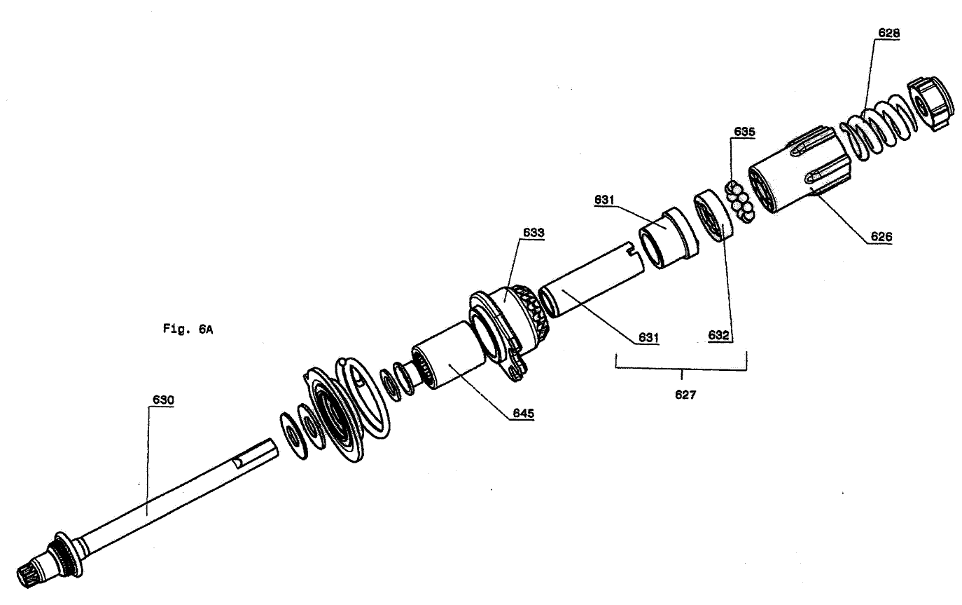

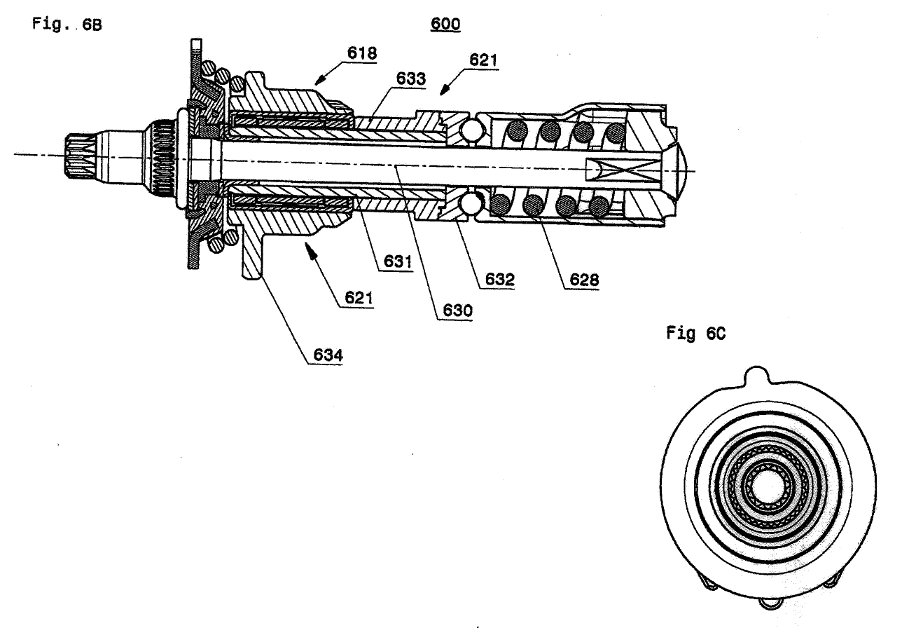

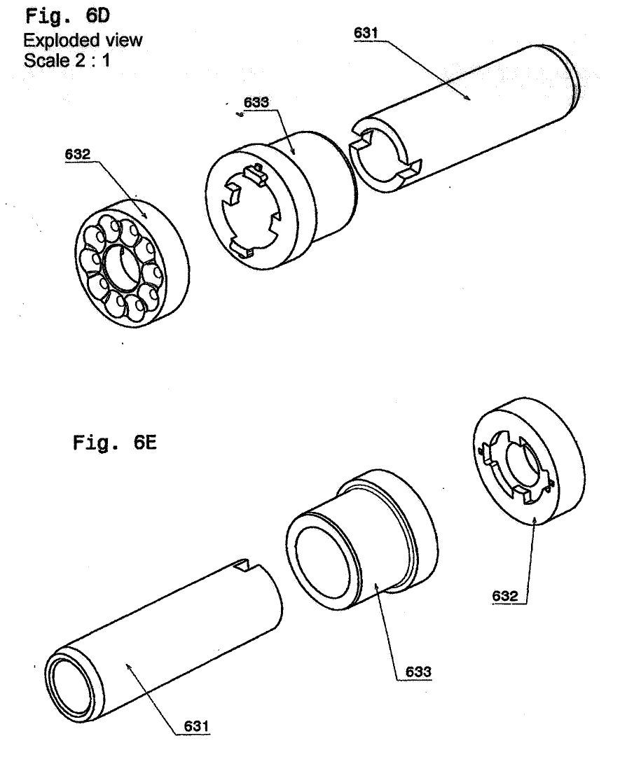

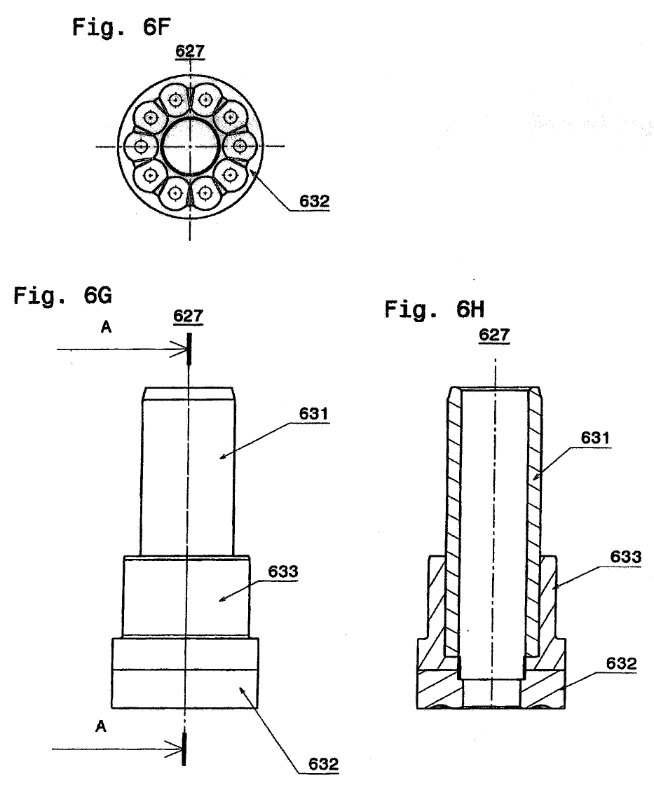

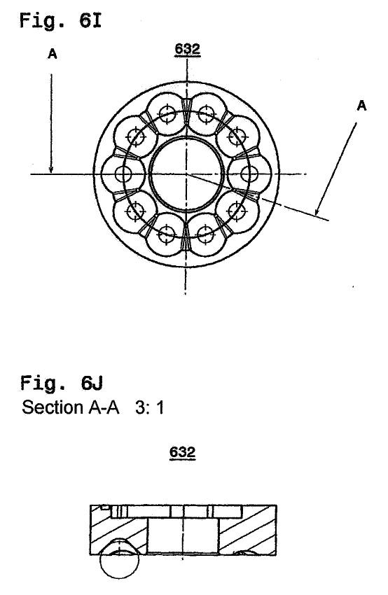

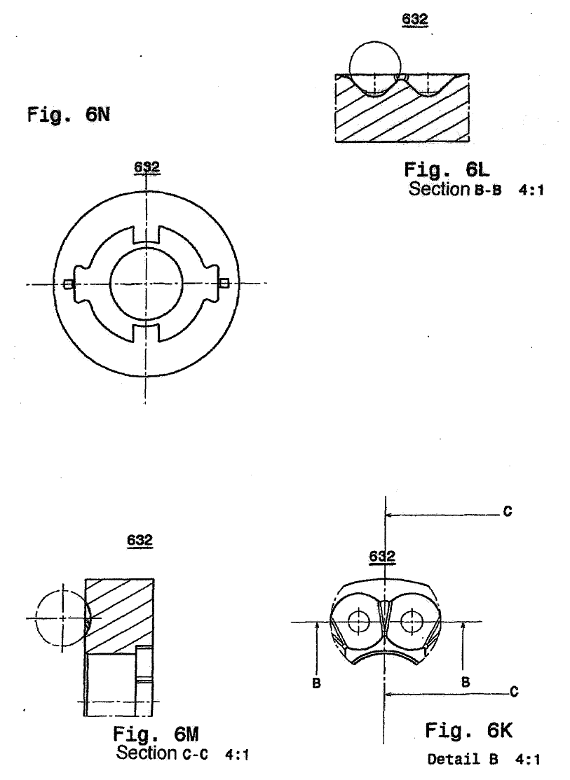

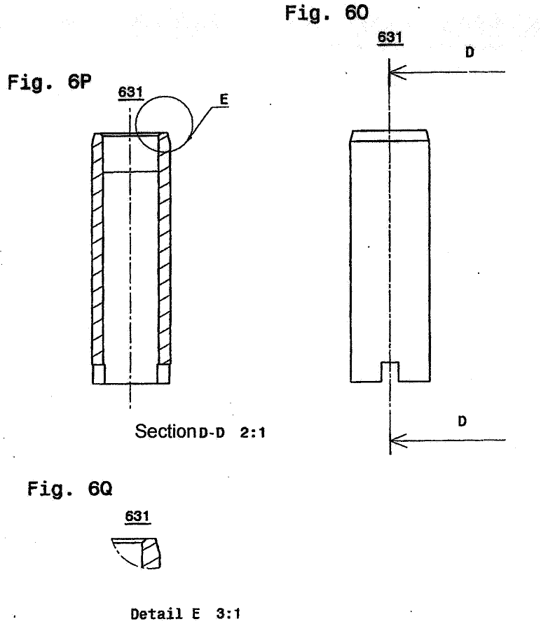

In the embodiment form shown in FIG. 3A, the structural component part 326, the clutch sleeve and the clutch bushing 327 are each made of drawn and hot-pressed metal parts. In the embodiment form shown here, these two structural component parts are shaped by cold pressing, whereupon cutting preworking is carried out, including production of the bore hole for receiving the pin 330. The material is then subjected to case hardening and finish cutting is then carried out after this heat treatment to achieve the fit quality. As a result of the multiple-step pressing process, the strength of the material has already been greatly increased by the time the spherical stamping is carried out, that is, when the recesses 329 are produced in the structural component parts 326 and 327. This can impair the stamping precision because the stamp may not be imparted in an optimal manner and also has a shorter useful life. An improvement is achieved according to FIGS. 6A to 6Q in that stamped metal parts are provided in place of drawn and hot-pressed metal parts, and the shaping areas are generated by plastic injection molding. The embodiment form according to 6A shows a three-part clutch bushing 627 comprising a clutch bushing plate 632 and a plastic injection molding 633 (see FIG. 6A and FIG. 6B) in assembled state, while FIGS. 6D and 6E show the three parts separately from one side and the other side in perspective. FIGS. 6F, 6G and 6H show three different views, namely, a front view, a side view and an axial sectional view of the assembled three structural component parts 631 (metal sleeve) 632 (clutch bushing plate) and 633 (plastic injection molding). FIGS. 6I and 6J show further details of the clutch bushing plate 632 in views increased in scale threefold.

Further details are shown in FIGS. 6K to 6N in a scale increased fourfold.

Details of the metal sleeve 631 are shown in FIGS. 6B to 6O in twofold and threefold scale, respectively.

FIG. 6B shows that the sleeve 631 is also part of the one-way rotation arrangement 318. By means of this one-way rotation clutch part 318 shown in FIGS. 3D and 3E, the freewheeling structural component part 318, which also only produces a rotational coupling in only one direction, forms a freewheel in the other direction. The one-way rotation clutch part 318 comprises a plurality of parts, namely, according to FIG. 3D, a metal part 334 which acts as a switching part and which is also shown in two views in FIGS. 3M and 3N and forms a clamping contour 335 for clamping cylinder rollers 336 between the clamping contour of the metal part 334 and the sleeve 327 and, accordingly, for connecting the sleeve 327 to the metal part during the clamping process so that it is rigid with respect to relative rotation.

Rotation in the opposite direction causes the roller 336 to disengage from the clamping contour and generates a free running between the two rotating parts.

The roller 336, more than one of which is provided, five in the present case, is guided through a cage formed of plastic as can be seen in FIGS. 3K, 3L, 3H, 3O, 3P and 3I. This plastic part 337 surrounding the metal part 334 carries catch hooks 339 for another plastic part 340 serving as a pipe stop. Spring elements 338 which proceed from the pipe stop 340 press against the roller by spring element 338 and bring the cylinder roller 336 into its unlocked position when the shift fork moves in this direction. The cylinder rollers 336 are each held axially by a plastic part 337 and 338, respectively (see reference numbers 341, 342).

A hot pressed part which has been reworked by cutting and a drawn part are accordingly replaced by a shift fork plate with a freewheel inner contour which can be produced by precision stamping.

Shaping areas are produced by plastic injection molding.

The individual metal springs used in the prior art construction are replaced by one piece through a spring component to facilitate assembly.

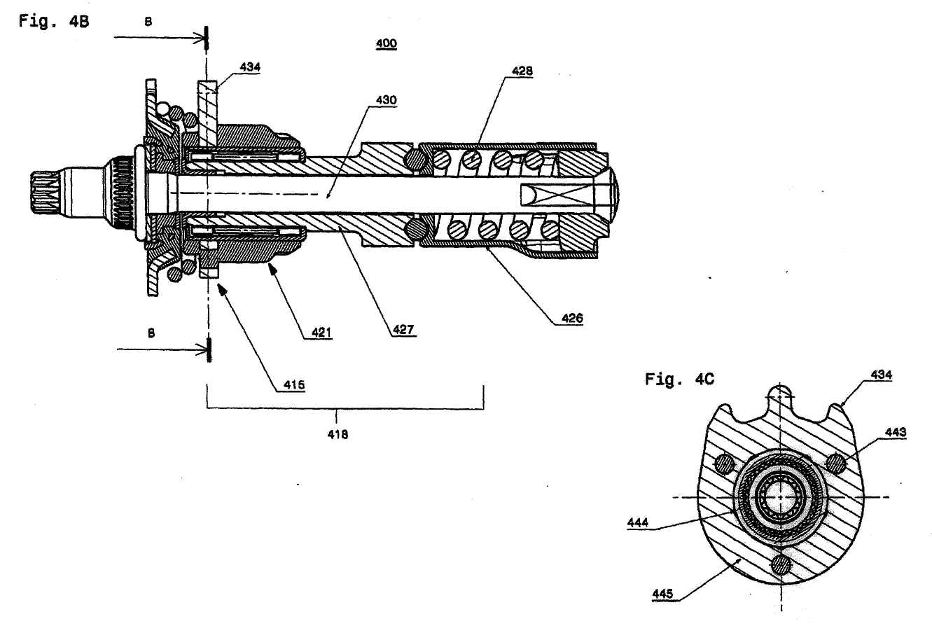

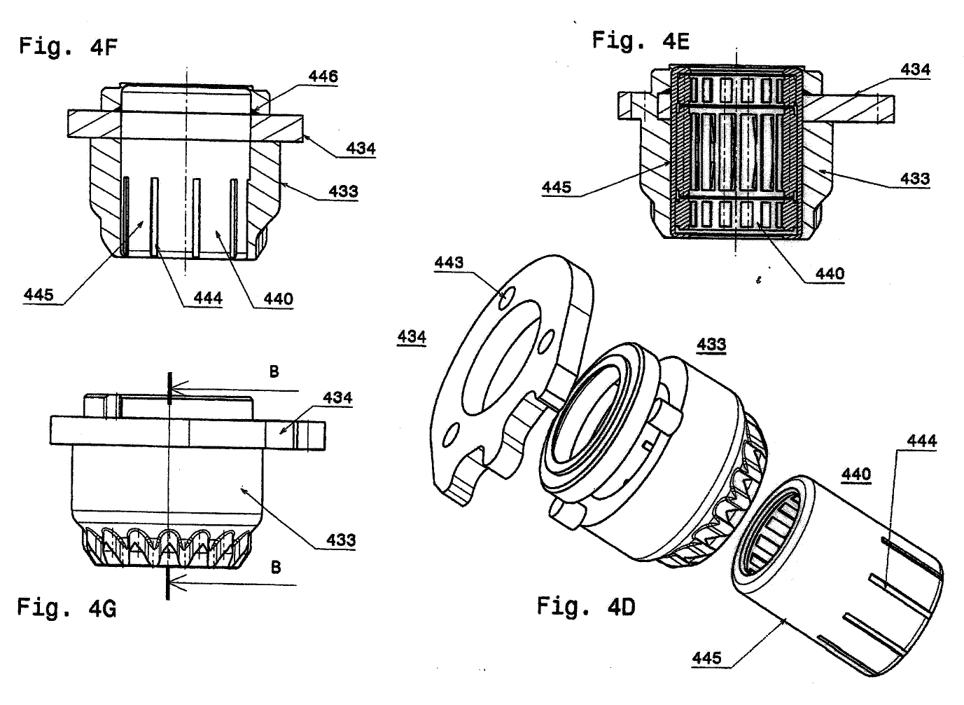

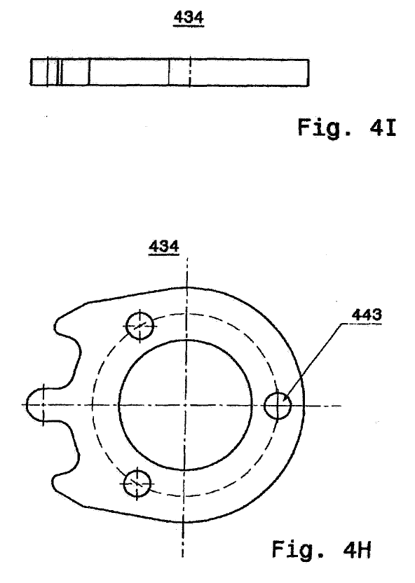

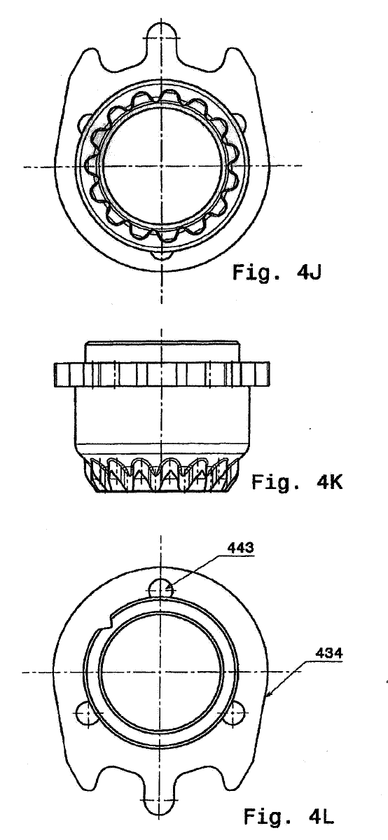

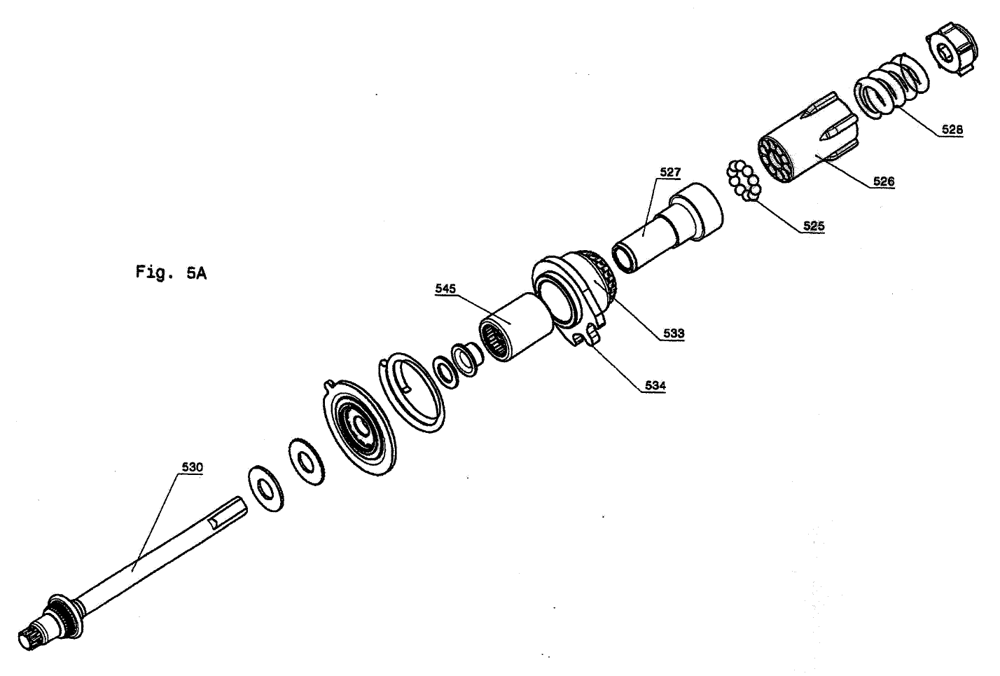

FIGS. 4A to 4L show another variant in which the shift fork 434 has bore holes 443 which are filled with plastic by hot injection molding and form an axial and radial securing arrangement by overmolded plastic. Grooves 444 in the outer surface of the structural component part 440 provide additional security.

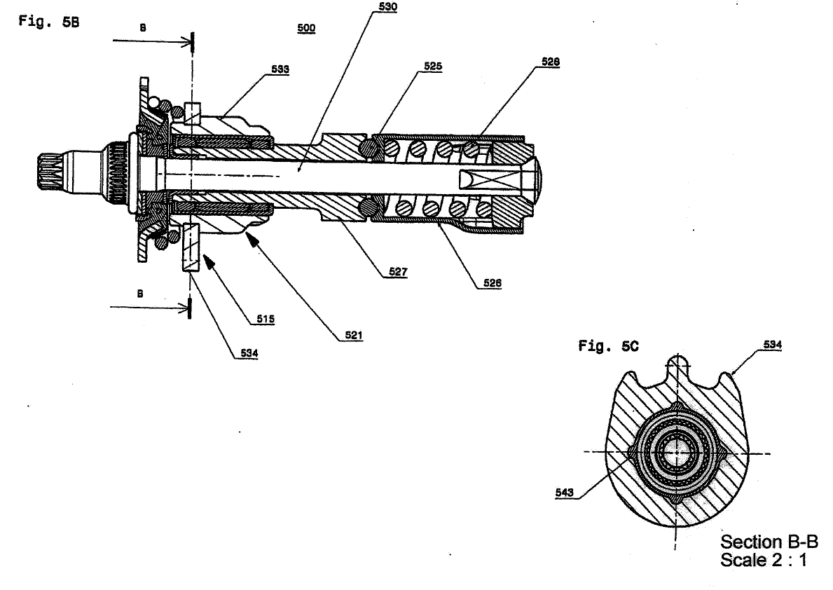

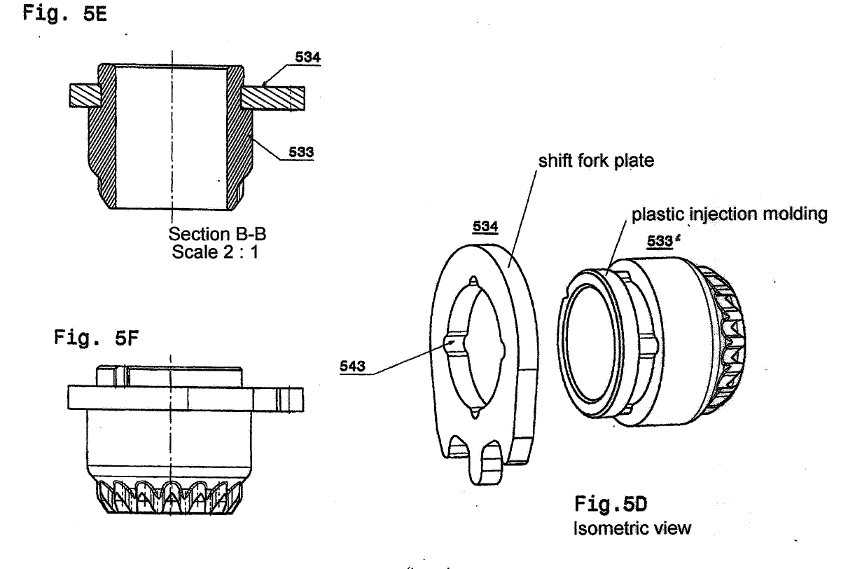

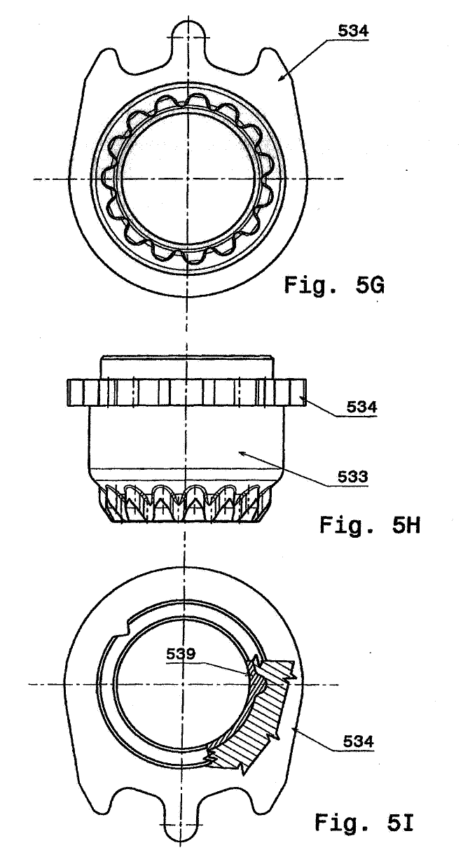

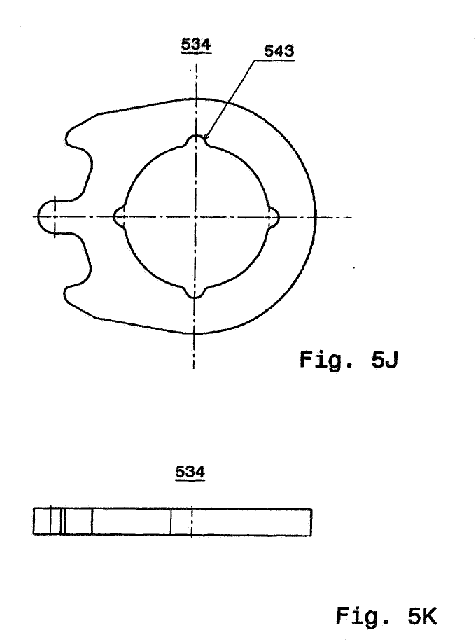

In the embodiment form according to FIGS. 5A to 5K, the shift fork comprises a metal plate 534 with plastic injection molding 533. In the plastic injection molding according to FIG. 4A, and following, and the plastic injection molding according to FIG. 5A, and following, there is an axial adhering of the overmolding of the end radii of the metal shift fork 434 and 534, respectively. In addition, the plastic is shrunk on the metal wall surface 445 when cooled and has sufficient torque transmitting properties to allow an initial overrunning.

In the exceptional event that the plastic does not offer adequate support, it can be reinforced by the switching plate, for example, by means of recesses 543 or apertures 443 or by grooves 444 as was already mentioned.

In the present embodiment form shown in FIG. 5A, and following, as well as in the embodiment form according to FIG. 4A, and following, sliding bearings are provided in place of needle bearings as bearing support for the freewheel. The advantage of the embodiment form according to FIG. 4A and FIG. 5A also consists in that the metal part 434 or 534 can have a center aperture which can be produced by stamping and which need not be an exact fit because it is closed by plastic. In the other embodiment forms, this center bore hole must be reworked, e.g., by friction.

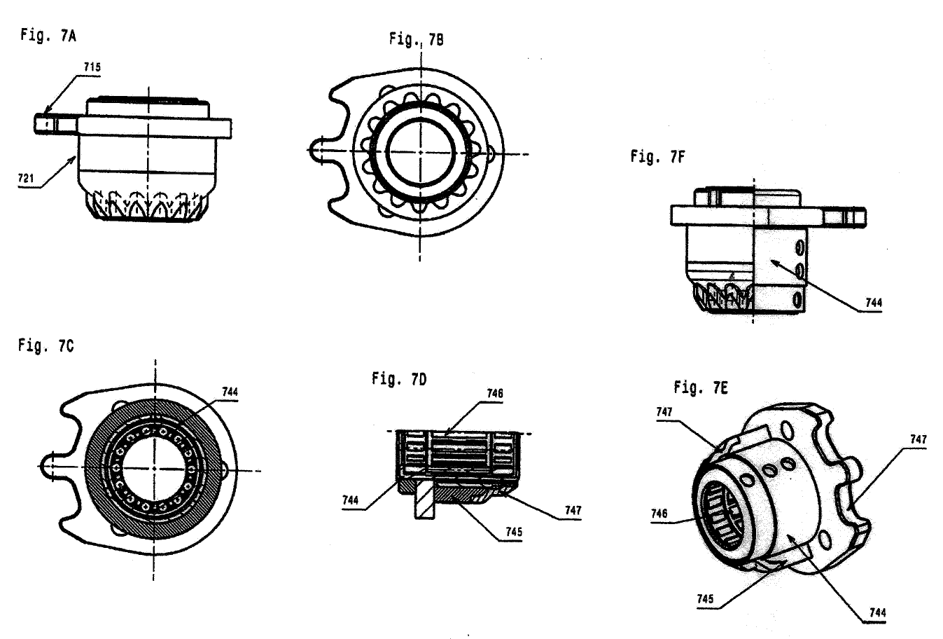

In a side view of another embodiment form, FIG. 7A shows the clamping roller freewheel 721 of a one-way rotation and overload clutch arrangement which exhibits the peculiarity of having a perforated metal sleeve 744 that absorbs the radial pressure of the clamping rollers, relieves the enveloping plastic 745 and ensures a reliable clamping. In this connection, reference is had also to FIG. 7B which shows a view from the left-hand side according to FIG. 7A, FIG. 7C which shows a radial sectional view, FIG. 7D which shows an axial sectional view, FIG. 7E which shows a perspective view, and FIG. 7F which shows a side view with the plastic partially removed to show a reinforcement of the arrangement by means of the perforated metal sleeve 744. Further, the drawings show a sheet metal facing 747 of the shift fork teeth which prevents premature wear of a shift fork made of plastic.

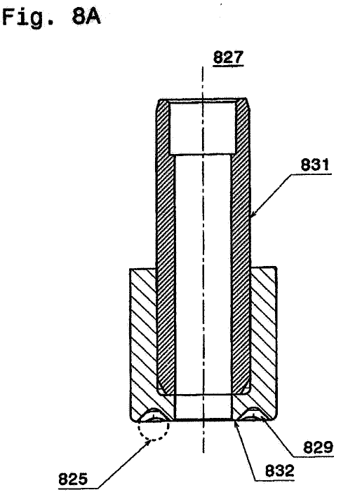

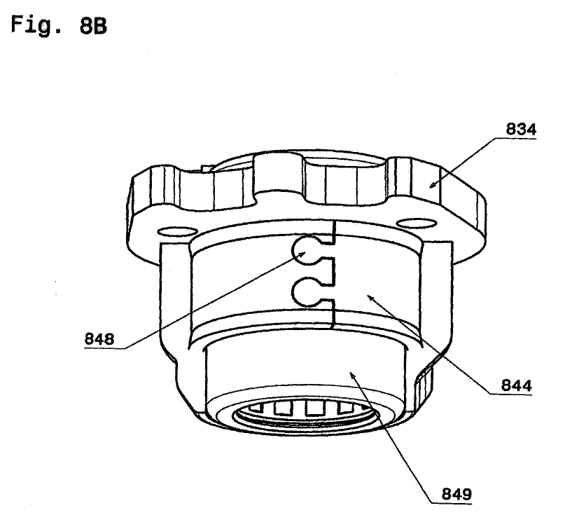

According to a further development of the invention, the one-way rotation and overload clutch arrangement has a two-part clutch bushing 827 comprising a sleeve 831 and a metal cap 832 which can be fitted to the latter, has recesses 829 for balls 825 and a radial press fit (see FIG. 8A).

The shift fork 834 with the freewheel sleeve can have a metal ring to stabilize the radial dimension and this metal ring can be fashioned in conventional manner as a closed ring or, optionally, from curved strip material (see reference number 844 in FIG. 8B) which engages by positive engagement at the end faces (reference number 848).

The ring 844 which is bent and closed at the end faces is passed to size on the inside and straightened circumferentially, which has the advantage that the closure contours 848 are tensioned to abut at one another when the pass dimension is reached.

The ring 844 which is bend and closed at the front ends can be perforated (not shown) to improve its connection to the plastic.

### COMMERCIAL APPLICABILITY

The invention is commercially applicable in vehicle manufacturing.

While this invention has been described in conjunction with the specific embodiments outlined above, it is evident that many alternatives, modifications, and variations will be apparent to those skilled in the art. Accordingly, the preferred embodiments of the invention as set forth above are intended to be illustrative, not limiting. Various changes may be made without departing from the spirit and scope of the inventions as defined in the following claims.

### REFERENCE NUMBERS

1 brake disk
2 brake caliper
3 roller bearings
4 cam lever
5 lever
6 cross member
7 adjusting spindle
8 adjusting spindle
9 pressure piece
10 brake lining
11 holder
12 toothed belt
13 holding member
14 rotary drive
15 driving lever
16 stop pin
17 shaft
18 torque limiting device
19 axial groove
20 projection
21 clamping roller freewheel
22 helical pressure spring
23 stationary part
24 friction surface
25 balls
300, 400, 600 wear adjustment device
315, 715 rotary lever
318, 321, 418, 521, 618, 621, 721 one-way rotation and overload clutch arrangement
325, 525, 625, 825 balls
326, 426, 526, 626 clutch sleeve
327, 427, 527, 627, 827 clutch bushing
328, 428, 528, 628 pressure spring
329, 829 recesses
330, 430, 530, 630 pin, clutch shaft
631, 831 metal sleeve
632, 832 clutch bushing plate
433, 533, 633 plastic injection molding
334, 434, 535, 834 shift fork, metal part
335 clamping contour
336 cylinder rollers
337 plastic injection molding
338 spring element
339 catch hook
340, 440 pipe stop
341 guide
342 guide
443, 543 aperture, recess
444 grooves
445, 545 outer surface
446 weld spot, weld seam
744, 844 perforated metal sleeve
745 plastic injection molding
746 clamping rollers
747 sheet metal facing
848 positive engagement
849 freewheel sleeve

1. A clutch arrangement for a wear adjustment device for a disk brake in vehicles;
wherein, in the wear adjustment device, a rotating lever which is actuated during braking acts on at least one displaceable element which actuates at least one adjusting spindle which presses a brake lining in direction of a brake disk;
wherein the adjustment device is so designed that it adjusts the adjusting spindle by continued rotation, a one-way rotation and overload clutch arrangement which blocks in the adjusting direction being provided for this purpose;
wherein stamped metal parts are provided in the one-way rotation and overload clutch arrangement instead of drawn and hot-pressed metal parts, and the shaping areas are generated by means of plastic injection molding;
wherein the one-way rotation and overload clutch arrangement comprises a clutch bushing which is fashioned by stamping soft-annealed strip material;
wherein the one-way rotation and overload clutch arrangement comprises a switching part which is worked up from seamlessly drawn pipe; and
wherein a multiple-part clutch bushing and a tubular switching part are inserted one inside the other in a positive engagement in the one-way rotation and overload clutch arrangement and are connected to one another by plastic injection molding.

2. The clutch arrangement according to claim 1;
wherein a positive engagement is provided between the stamped metal parts and the plastic overmolding and possibly also between the stamped metal parts themselves.

3. The clutch arrangement according to claim 2;
wherein the stamped metal parts comprise a shift fork plate and a freewheel sleeve which are provided with plastic overmolding.

4. The clutch arrangement according to claim 3;
wherein the shift fork plate and/or the freewheel sleeve have projections or recesses on the plate and/or projecting strips or grooves on the outer sleeve surface.

5. The clutch arrangement according to claim 1;
wherein welds or weld seams provide additional support.

6. The clutch arrangement according to claim 1;
wherein end radii which are overmolded with plastic are provided in the one-way rotation and overload clutch arrangement instead of machined metal surfaces to produce a fit for axially securing a freewheel arrangement.

7. The clutch arrangement according to claim 6;
wherein the plastic of the end radii which are overmolded with plastic is shrunk on the outer surfaces when cooled.

8. The clutch arrangement according to claim 7;
wherein the support that can be transmitted by the shrunk-on plastic is reinforced by a switching plate.

9. The clutch arrangement according to claim 1;
wherein a one-piece or two-piece plastic part which is injection molded from plastic is provided in the one-way rotation and overload clutch arrangement instead of metal spring elements.

10. The clutch arrangement according to claim 1;
wherein sliding bearings are provided in the one-way rotation and overload clutch arrangement for the bearing support of the freewheel arrangement instead of needle bearings.

11. The clutch arrangement according to claim 1;
wherein the one-way rotation and overload clutch arrangement makes use of plastic injection-molded connections such as the connection between the clutch bushing and the switching part instead of machined metal stop edges.

12. The clutch arrangement according to claim 1;
wherein the freewheel sleeve having a plastic injection molding is outfitted with a perforated sleeve to strengthen the plastic injection molding.

13. The clutch arrangement according to claim 1;
wherein the shift fork made of plastic has a sheet metal reinforcement in the toothed area.

14. The clutch arrangement according to claim 1;
wherein the one-way rotation and overload clutch arrangement has, as a clutch bushing, a sleeve with a metal cap with radial press fit which is fitted thereto and which has recesses.

15. The clutch arrangement according to claim 13;
wherein the freewheel sleeve has a metal ring defining the circumferential dimension.

16. The clutch arrangement according to claim 15;
wherein the metal ring is fashioned as a closed ring or is fashioned from curved strip material whose end faces engage in one another.

17. The clutch arrangement according to claim 16;
wherein the ring is perforated.
